(19) United States
(12) Patent Application Publication
(10) Pub. No.: US 2025/0178747 A1
(43) Pub. Date: Jun. 5, 2025

(54) APPARATUS AND METHOD FOR MOVING AIRCRAFT

(71) Applicants: Hyundai Motor Company, Seoul (KR); Kia Corporation, Seoul (KR)

(72) Inventors: Jae Hak Kim, Hwaseong-si (KR); Jun Ki Choi, Seoul (KR)

(21) Appl. No.: 18/619,462

(22) Filed: Mar. 28, 2024

(30) Foreign Application Priority Data
Dec. 4, 2023 (KR) 10-2023-0173657

(51) Int. Cl. B64F 1/228; B64F 1/227

(52) U.S. Cl. CPC B64F 1/228; B64F 1/227

(57) ABSTRACT

An embodiment apparatus for moving an aircraft includes a first moving robot configured to lift and support a first landing gear of the aircraft, a second moving robot configured to lift and support a plurality of second landing gears of the aircraft, and a control device electrically connected to the first moving robot and the second moving robot, respectively, wherein the control device is configured to transmit a synchronized control signal to enable the first moving robot and the second moving robot to perform platooning.

### CROSS-REFERENCE TO RELATED APPLICATIONS

This application claims the benefit of Korean Patent Application No. 10-2023-0173657, filed on Dec. 4, 2023, which application is hereby incorporated herein by reference.

### TECHNICAL FIELD

The present disclosure relates to an apparatus and a method for moving an aircraft.

### BACKGROUND

A commercial aircraft taxis to a runway from a gate of an airport before takeoff or taxis from the runway to the gate after landing. For such taxiing, the aircraft uses the thrust produced through the driving of the engine. Usually, since an engine is not designed to operate efficiently in a low-power state, the taxiing of the aircraft has a disadvantage of consuming a large amount of fuel.

In order to optimize the use of fuel, a towing method may be implemented, in which an aircraft is moved by a nose landing gear thereof being pulled by a tractor such as a towing car or a taxi-bot. However, the towing method may put load on the nose landing gear, which may result in a problem of fatigue or damage to components, with accompanying frequent maintenance cycles and replacement of components.

Furthermore, the tightening of a tow bar, essential to connect the tractor to the aircraft, is a high-intensity task that uses heavy objects, which may lead to musculoskeletal diseases and safety accidents for workers. Additionally, the tractor may emit more than five times more exhaust gas than an internal combustion engine vehicle, which may cause environmental problems such as air pollution and noise pollution during operation.

On the other hand, when the aircraft is applied as a means of transportation in the city, the aircraft must be taxied by a certain distance for the purpose of passengers embarking and disembarking, loading and unloading cargo, parking, charging, and maintenance, in addition to taking off and landing in a narrow take-off and landing site, such as a vertiport or vertistop installed on the roof of a building. Therefore, a solution is required to quickly and safely move the aircraft without interference with other buildings, other facilities, or other aircraft in a narrow take-off and landing site.

### SUMMARY

The present disclosure relates to an apparatus and a method for moving an aircraft. Particular embodiments relate to an apparatus and a method for moving an aircraft that may move the aircraft in a narrow take-off and landing site, such as a vertiport or a vertistop installed on the roof of a building.

An embodiment of the present disclosure provides an apparatus and a method for moving an aircraft, which can quickly and safely move the aircraft in a narrow take-off and landing site.

Furthermore, another embodiment of the present disclosure provides an apparatus and a method for moving an aircraft, which can reduce worker man-hours and prevent musculoskeletal diseases and safety accidents of workers.

Furthermore, another embodiment of the present disclosure provides an apparatus and a method for moving an aircraft, which can solve environmental problems such as air pollution and noise pollution when operating in a city center.

According to an embodiment of the present disclosure, an apparatus for moving an aircraft may include a first moving robot configured to lift and support a single first landing gear of the aircraft, a second moving robot configured to lift and support a plurality of second landing gears of the aircraft, and a control device electrically connected to the first moving robot and the second moving robot, respectively, to control operations thereof, and configured to transmit a synchronized control signal to enable the first moving robot and the second moving robot to perform platooning.

The first moving robot may include a first frame, at least two pairs of first wheels disposed on both sides of the first frame in left and right directions, and an arm portion provided on one side of the first frame in a front-rear direction to support a wheel of the first landing gear in a state in which the wheel is restrained and lifted in front and rear sides.

The first wheels may be driven independently to drive and steer the first moving robot.

The arm portion may include a pair of arm members extending in the front-rear direction from one side of the first frame, a slide connecting ends of the pair of arm members and having an inclined surface on one side thereof, a pair of guides installed on the other side of the slide and configured to be capable of reciprocating in left and right directions of the first frame, and a support portion disposed between the pair of arm members.

Each guide may have an inclined surface formed downwardly toward an interior of the first frame on one side thereof, and the support portion may have an inclined surface formed downwardly toward the outside of the first frame on one side thereof, corresponding to the inclined surface of the guide.

A buffer member formed of an elastic material or a plurality of rolling members arranged in the left and right directions of the first frame may be mounted on the inclined surface of the guide and the inclined surface of the support portion.

The support portion may be installed to enable linear reciprocating movement on the arm member.

The first moving robot may include a first sensor unit configured to sense a position of the wheel of the first landing gear and a surrounding environment and a first controller electrically connected to the first sensor unit and configured to control at least driving of the first wheel and driving of the guide.

The first controller may include a first memory or may be electrically connected thereto, and the first memory may share and store a map and a coordinate system with the control device.

The first controller may be electrically connected to a first communication module and may communicate with the control device and the second moving robot through the first communication module.

The second moving robot may include a second frame, at least two pairs of second wheels disposed on both sides of the second frame in the left and right directions, and a pair of swing units disposed on both sides of the second frame in the left and right directions and configured to support a wheel of the second landing gear while lifting the wheel, wherein the second wheels may be driven independently to drive and steer the second moving robot.

The swing unit may include a pair of wing members disposed to be spaced apart from each other in the front-rear direction on one side of the second frame and a driver connected to one end of each wing member to rotate the wing member, wherein, when each wing member is unfolded to narrow a gap between the pair of wing members, the wheel of the second landing gear may be supported while being lifted on the pair of wing members.

Each of the pair of wing members may have inclined surfaces formed downwardly toward each other on surface sides facing each other in an unfolded state, and a buffer member formed of an elastic material or a plurality of rolling members arranged along each wing member longitudinal direction may be mounted on the inclined surface.

The second moving robot may include a second sensor unit configured to sense a position of the wheel of the second landing gear and a surrounding environment and a second controller electrically connected to the second sensor unit and configured to control driving of the second wheel and driving of the swing unit.

The second controller may include a second memory or may be electrically connected thereto, and the second memory may share and store a map and a coordinate system with the control device.

The second controller may be electrically connected to a second communication module and may communicate with the control device and the first moving robot through the second communication module.

The control device may include a communication unit configured to communicate with the first moving robot and the second moving robot, a path generation unit configured to generate a synchronized platooning path according to positions of the first moving robot and the second moving robot in a coordinate system of a map, a storage unit configured to store a program and data, and a control unit configured to grasp state information of the first moving robot and the second moving robot and to control the first moving robot and the second moving robot to move along the platooning path.

The control device may further include a terminal configured to receive setting information for a destination and a movement path and to display monitoring information of the first moving robot and the second moving robot.

According to an embodiment of the present disclosure, a method for moving an aircraft may include lifting and supporting, by a first moving robot, a single first landing gear of an aircraft, lifting and supporting, by a second moving robot, a plurality of second landing gears of the aircraft, and performing platooning by the first moving robot and the second moving robot.

In the lifting and supporting the aircraft, the first moving robot may enter underneath the aircraft and move to a center of a wheel width of a wheel of the first landing gear, and the second moving robot may enter underneath the aircraft and move between wheels of the plurality of second landing gears.

According to an embodiment of the present disclosure, since the aircraft is at least partially lifted and moved using a moving robot without towing the aircraft, it may be possible to obtain the effect of quickly and safely moving the aircraft even within a narrow space with a free transfer trajectory.

Additionally, according to an embodiment of the present disclosure, an aircraft may be moved automatically through a moving robot, which may significantly reduce the worker man-hours, and furthermore, it may be possible to prevent musculoskeletal diseases and safety accidents of workers in advance by not using a heavy tow bar.

Additionally, according to an embodiment of the present disclosure, by utilizing a motor-driven moving robot, even if the moving robot operates in the city center, it may be possible to solve environmental problems such as air pollution and noise pollution.

### BRIEF DESCRIPTION OF THE DRAWINGS

The above and other aspects, features, and advantages of embodiments of the present disclosure will be more clearly understood from the following detailed description, taken in conjunction with the accompanying drawings, in which:

FIG. 1 is a perspective view illustrating a first moving robot constituting an apparatus for moving an aircraft according to embodiments of the present disclosure;

FIG. 2 is a perspective view illustrating a second moving robot constituting an apparatus for moving an aircraft according to embodiments of the present disclosure;

FIG. 3 is a block diagram schematically illustrating a control relationship of an apparatus for moving an aircraft according to embodiments of the present disclosure;

FIG. 4 is a side view illustrating an operating state of an apparatus for moving an aircraft according to embodiments of the present disclosure;

FIG. 5 is a view illustrating an application example of an apparatus for moving an aircraft according to embodiments of the present disclosure; and

FIG. 6 is a flowchart illustrating a method for moving an aircraft according to embodiments of the present disclosure.

### DETAILED DESCRIPTION OF ILLUSTRATIVE EMBODIMENTS

Hereinafter, embodiments of the present disclosure will be described in detail with reference to the accompanying drawings. In adding reference numerals to elements of each of the drawings, although the same elements are illustrated in other drawings, like reference numerals may refer to like elements.

An apparatus for moving an aircraft according to embodiments of the present disclosure may include a first moving robot, a second moving robot, and a control device. Here, the first moving robot and the second moving robot may include, for example, an autonomous mobile robot (AMR).

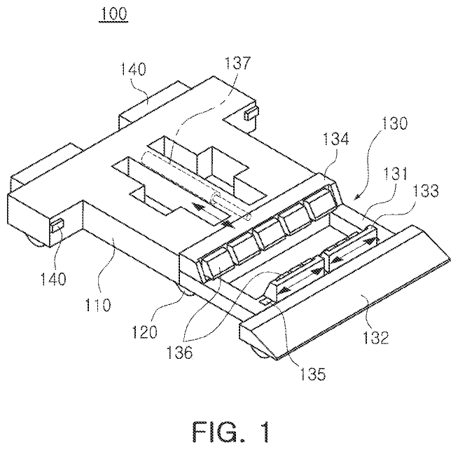

FIG. 1 is a perspective view illustrating a first moving robot constituting an apparatus for moving an aircraft according to embodiments of the present disclosure.

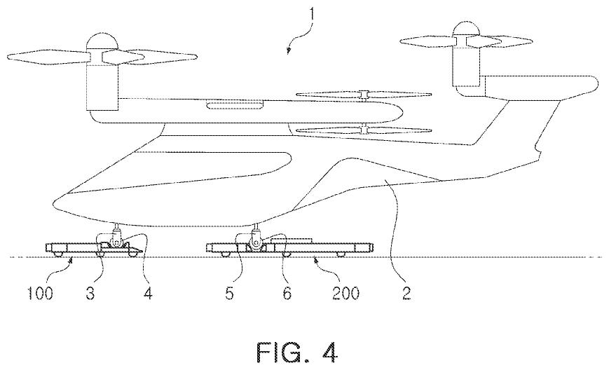

A first moving robot 100 of embodiments of the present disclosure may lift and move a wheel 4 (see FIG. 4) that constitutes one first landing gear 3 disposed in a center of left and right sides of a fuselage 2 from the ground in the front or rear of an aircraft 1. To this end, the first moving robot of embodiments of the present disclosure may include a first frame 110, a plurality of first wheels 120, and an arm portion 130.

The first frame 110 may be formed in a substantially rectangular frame shape and may implement an external appearance of the first moving robot 100. The first frame may support components of the first moving robot 100.

Furthermore, the first frame 110 may have sufficient rigidity to lift and support the wheel 4 of the first landing gear 3, along with some of a load of the aircraft 1. Additionally, the first frame may have a predetermined length (length in a front-rear direction) and a predetermined width (length in a left-right direction).

The plurality of first wheels 120 may be disposed on both left and right sides of a lower surface of the first frame 110, respectively. For stable support, at least two pairs of first wheels 120 may be mounted on the first frame 110.

Each of the plurality of first wheels 120 may be driven by a motor and may be driven independently of each other. For example, power for forward rotation may be applied to a motor of first wheels on one side of left and right sides, and power may not be applied or power for reverse rotation may be applied to a motor of first wheels on the other side thereof, thereby achieving steering.

In this manner, as the plurality of first wheels 120 are driven independently of each other, the first moving robot 100 may move forward or backward as well as freely change a direction.

Optionally, each of first wheels 120 may be provided with an in-wheel motor and may be driven by the in-wheel motor. As the in-wheel motor is driven in forward and reverse rotation, the first wheel may rotate forward or backward to move the first frame 110 in a front-rear direction. Furthermore, as a plurality of in-wheel motors are driven independently of each other, the first wheels on both the left and right sides may rotate in different directions or the first wheels on one side may be stopped to perform steering.

Accordingly, the first moving robot 100 may freely change a direction and move in a front-rear direction and a left-right direction.

The arm portion 130 may include a pair of arm members 131 extending in the front-rear direction from one side of the first frame 110, a slide 132 connecting ends of the pair of arm members and having an inclined surface on one side, a pair of guides 133 installed on the other side of the slide and configured to be capable of reciprocating in the left and right directions of the first frame, and a support portion 134 disposed between the pair of arm members.

The slide 132 may have an inclined surface formed downwardly toward the outside of the first frame 110 on one side thereof. The slide 132 may be disposed at a lower height than the arm member 131, or the slide 132 may have a thinner thickness than the arm member 131. Accordingly, when the first frame 110 travels toward the wheel 4 of the first landing gear 3, the wheel 4 of the first landing gear 3 may easily ride over the slide 132.

The guide 133 may be driven by a linear motion guide 135 equipped with a first drive motor and a ball screw so as to enable linear reciprocating movement of the guide 133. To this end, a pair of linear motion guides 135 disposed to extend along the slide in a longitudinal direction may be installed on the other side of the slide 132. The guide may be mounted on a nut portion of the linear motion guide.

Accordingly, the pair of guides 133 may be moved toward or away from each other. However, a driving means of the guide 133 is not necessarily limited to the aforementioned example, and for example, a hydraulic cylinder equipped with an actuating rod may be adopted as a means of driving the guide.

Specifically, as illustrated in FIG. 1, in a state in which both guides 133 mounted on the slide 132 are in contact with each other, when the first moving robot 100 approaches the wheel 4 of the first landing gear 3, the guides 133 may move away from each other to allow the wheel 4 to ride over the slide 132 and enter a space between the arm members 131.

Then, the guides 133 may move toward and contact each other, so that one side of each of the guides 133 may be in contact with the wheel 4 to support the wheel 4.

Each guide 133 may have an inclined surface formed downwardly toward an interior of the first frame 110 on one side thereof. Substantially, the wheel 4 of the first landing gear 3 may be in contact with the inclined surface of the guide 133, and when the wheel 4 is restrained by the support portion 134 on an opposite side thereof, the wheel 4 may be supported while being lifted at least on the inclined surface of the guide 133.

Furthermore, in order to prevent the guide 133 from impacting and damaging a tire of the wheel 4 when the guide 133 is in contact with the wheel 4, a buffer member 136 formed of an elastic material may be mounted on the inclined surface of the guide.

Alternatively, on the inclined surface of the guide 133, a plurality of rolling members such as ball members or roller members may be disposed along the first frame 110 in the left-right direction. In this manner, the plurality of rolling members may be disposed on the inclined surface, and accordingly, as the wheel 4 of the first landing gear 3 is in contact with the rolling member, the wheel 4 may ascend along the inclined surface, thereby minimizing impacts upon contact and enabling smooth lifting while preventing damage to the wheel 4.

The support portion 134 corresponds to the inclined surface of the guide 133, that is, one side thereof may have an inclined surface formed downwardly toward the outside of the first frame 110.

Similarly, on the inclined surface of the support portion 134, the buffer member 136 formed of an elastic material may be mounted or a plurality of rolling members such as ball members or roller members may be arranged.

Optionally, the support portion 134 may be installed to enable linear reciprocating movement on the arm member 131. The support portion 134 may be driven by an electric actuator 137 equipped with an operating rod. To this end, the first frame 110 may be equipped with an electric actuator in which the operating rod is disposed to expand and contract along the first frame 110 in the front-rear direction. However, the driving means of the support portion 134 is not necessarily limited to the above-described examples, and for example, a fluid pressure cylinder equipped with the operating rod may be adopted as a means for driving the support portion 134.

Accordingly, the support portion 134 may be moved toward the pair of guides 133, and accordingly, the support portion 134 together with the guides 133 may restrain the wheel 4 of the first landing gear 3 that has entered a space between the arm members 131 in front and rear sides. Accordingly, the wheel 4 may be supported while being lifted at least on the inclined surface of the support portion 134.

The first moving robot 100 of embodiments of the present disclosure may sense a position of the wheel 4 constituting the first landing gear 3 of the aircraft 1 and may move to a set position based on the position of the wheel 4. For this purpose, the first moving robot 100 may include a first sensor unit 140 sensing a position of the wheel and a surrounding environment thereof and a first controller 150 electrically connected to the first sensor unit 140 and controlling driving of the first wheels 120, driving of the guides 133, and driving of the support portion 134.

Specifically, the first moving robot 100 may sense a position of the aircraft 1 and move toward a stationary aircraft. The first moving robot may enter space below the aircraft and may accurately sense the position of the wheel 4 constituting the first landing gear 3 through the first sensor unit 140 and may move to a center of a wheel width of the wheel 4 based on the sensed position. The first sensor unit 140 may include, for example, a lidar sensor and an image sensor.

When sensing a corresponding wheel 4 of the first landing gear 3, the first sensor unit 140 may sense the position of the wheel 4 by distinguishing between the front and the rear of the aircraft 1. For example, when the first landing gear 3 disposed in a center between a left side and a right side of the fuselage 2 is disposed in front of the aircraft, in a state in which the first sensor unit 140 senses a shape of a nose of the aircraft 1 to determine that the first moving robot 100 is adjacent to the front of the aircraft 1, the first moving robot 100 may approach the wheel 4 sensed first after entering underneath the aircraft 1 from the front of the aircraft 1.

Conversely, in a state in which the first sensor unit 140 senses a shape of a rear of the aircraft 1 to determine that the first moving robot 100 is adjacent to the rear of the aircraft 1, the first moving robot 100 may move from the rear of the aircraft 1 to the lower portion of the aircraft 1 and may then access the wheel 4 sensed secondly.

The first sensor unit 140 may transmit a sensed position of the wheel 4 to the first controller 150, and the first moving robot 100 may move and approach the corresponding wheel 4 of the first landing gear 3 provided in the lower portion of the aircraft 1 under the control of the first controller 150 and then move to allow the slide 132 to push between the wheel 4 and the ground. Accordingly, when the wheel 4 goes over the slide 132 and enters the space between the arm members 131, unfolded guides 133 move toward each other and are in contact with each other.

Next, the support portion 134 moves toward the guides 133, and the wheel 4 may be restrained in the front and rear sides by the support portion 134 together with the guides 133 and may be simultaneously supported while being lifted from the ground.

The first moving robot 100 may perform autonomous driving, and a driving direction, a driving speed, a turning direction, a turning speed, a stopping position, an obstacle avoidance, an emergency stop, and the like may be controlled by the first controller 150. In order to control such autonomous driving, the moving robot may be equipped with a battery (not illustrated).

Since various technologies have been proposed and are known for controlling a moving robot or vehicle by a controller, such as the first controller 150, for autonomous driving, a detailed description thereof will be omitted in this specification.

The first controller 150 may control a motor, such as an in-wheel motor, provided for each first wheel 120 of the first moving robot 100, a first drive motor of the linear motion guide 135 driving the guide 133, and the electric actuator 137 driving the support portion 134. Accordingly, the first controller 150 may control the in-wheel motor to control the driving and steering of the first moving robot 100 and may control the first drive motor of the linear motion guide 135 and the electric actuator 137 so that the support portion 134 along with the guides 133 may restrain the wheel 4 of the first landing gear 3 and may simultaneously lift the wheel 4.

The first controller 150 may be implemented with various processing devices such as a microprocessor embedded with a semiconductor chip capable of performing various operations or commands, and various implementation methods are already widely known, and thus, further explanation thereof is omitted.

The first controller 150 may include a first memory 160 or may be electrically connected thereto. The first memory 160 may store various programs and data for driving the first moving robot 100. The first memory 160 may share and store a previously generated map and coordinate system of a take-off and landing site with a control device 300.

Additionally, the first controller 150 may be electrically connected to a first communication module 170 and may communicate with the control device 300 and a second moving robot 200 through the first communication module 170.

The first communication module 170 may be connected to at least one of, for example, wireless communication or wired or wireless communication. For example, the first communication module 170 may wirelessly receive a control signal from the control device 300 and may transmit state information of the first moving robot 100 to the control device 300.

Furthermore, the first communication module 170 may communicate with the second moving robot 200 and may receive information on a position or a state of the second moving robot 200, and conversely, the first communication module 170 may transmit the information on the position or the state of the first moving robot 100 to the second moving robot 200.

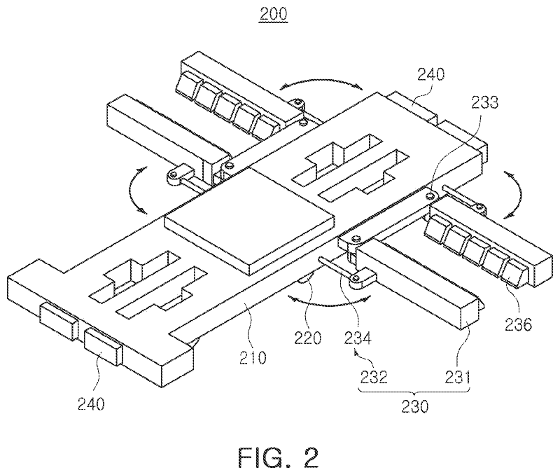

FIG. 2 is a perspective view illustrating a second moving robot constituting an apparatus for moving an aircraft according to embodiments of the present disclosure.

The second moving robot 200 of embodiments of the present disclosure may lift and move a wheel 6 (see FIG. 4) constituting a pair of second landing gears 5 symmetrically disposed on the left and right sides of a fuselage 2 from the ground in the rear or front of the aircraft 1. To this end, the second moving robot 200 of embodiments of the present disclosure may include a second frame 210, a plurality of second wheels 220, and a pair of swing units 230.

The second frame 210 may be formed in a substantially rectangular frame shape and may implement an external appearance of the second moving robot 200. The second frame 210 may support components of the second moving robot 200.

Furthermore, the second frame 210 may have sufficient rigidity to lift and support the wheel 6 of the second landing gear 5 along with some of the load of the aircraft 1. Additionally, the second frame 210 may have a predetermined length (length in the front-rear direction) and a predetermined width (length in the left-right direction).

The plurality of second wheels 220 may be disposed on both left and right sides of a lower surface of the second frame 210, respectively. For stable support, at least two pairs of second wheels 220 may be mounted on the second frame 210.

Each of the plurality of second wheels 220 may be driven by a motor and may be driven independently of each other. For example, power for forward rotation may be applied to a motor of second wheels 220 on one side of left and right sides, and power may not be applied or power for reverse rotation may be applied to a motor of second wheels 220 on the other side thereof, thereby achieving steering.

In this manner, as the plurality of second wheels 220 are driven independently of each other, the second moving robot 200 can move forward or backward as well as freely change a direction.

Optionally, each of the second wheels 220 may be provided with an in-wheel motor and driven by the in-wheel motor. As the in-wheel motor is driven in forward and reverse rotation, the second wheel 220 may rotate forward or backward to move the second frame 210 in the front-rear direction. Furthermore, as the plurality of in-wheel motors are driven independently of each other, the second wheels 220 on both the left and right sides may rotate in different directions or the second wheels 220 on one side may be stopped to perform steering.

Accordingly, the second moving robot 200 may freely change a direction and move in the front-rear direction and the left-right direction.

The pair of swing units 230 may be disposed in both ends of the second frame 210 in the left-right direction, respectively. Each of the swing units 230 may include a pair of wing members 231 disposed to be spaced apart from each other in the front-rear direction on one side of the second frame 210 and a driver 232 connected to one end of each wing member 231 to rotate each wing member 231.

Each of the wing members 231 is a substantially bar-shaped member, and one end thereof may be installed to be rotatable about a rotation axis 233. Accordingly, the pair of wing members 231 may be unfolded toward each other or folded away from each other.

In the unfolded state, each of the wing members 231 may be in contact with the wheel 6 of the second landing gear 5 in a front side or a rear side thereof to lift the wheel 6, and conversely, in the folded state, each of the wing members 231 does not restrict the wheel 6.

The pair of wing members 231 arranged back and forth may have inclined surfaces formed downwardly toward each other on side surfaces facing each other in the unfolded state.

Additionally, a buffer member 236 formed of an elastic material may be mounted on the inclined surface of each of the wing members 231, or a plurality of rolling members such as ball members or roller members may be arranged along the wing members 231 in the longitudinal direction.

The driver 232 drives a power transmission unit 234 connected to the wing member 231, by driving the second driving motor provided in the second frame 210, thus unfolding or folding the wing member 231. A rack and pinion mechanism may be adopted as a power transmission unit. However, the configuration of the driver is not necessarily limited to the above-described example, and for example, a fluid pressure cylinder equipped with an actuating rod may be adopted as the driver.

In one swing unit 230 on either the left or right side of the second frame 210, when front and rear wing members 231 are respectively unfolded by the driving of each driver 232 to narrow a gap between the two wing members 231, the wheel 6 of the second landing gear 5 may ascend along the inclined surface and may be supported while being lifted on the wing member 231.

The second moving robot 200 of embodiments of the present disclosure may detect a position of the wheel 6 constituting the second landing gear 5 of the aircraft 1 and may move to a set position based on the position of the wheel 6. For this purpose, the second moving robot 200 may include a second sensor unit 240 detecting the position of the wheel 6 and a surrounding environment thereof and a second controller 250 electrically connected to the second sensor unit 240 and controlling the driving of the second wheels 220 and the driver 232.

Specifically, the second moving robot 200 may detect the position of the aircraft 1 and may move toward the stationary aircraft. The second moving robot 200 may enter space below the aircraft 1 and may accurately sense the position of the wheel 6 constituting the second landing gear 5 through the second sensor unit 240 and may move between both wheels based on the sensed position. The second sensor unit 240 may include, for example, a lidar sensor and an image sensor.

When sensing the corresponding wheel 6 of the second landing gear 5, the second sensor unit 240 may sense the position of the wheel 6 by distinguishing between the front and rear of the aircraft 1. For example, when two second landing gears 5 arranged symmetrically on the left and right sides of the fuselage 2 are disposed behind the first landing gear 3, in a state in which the second sensor unit 240 senses the shape of the nose of the aircraft 1 to determine that the second moving robot 200 is adjacent to the front of the aircraft 1, the second moving robot 200 may approach between both wheels 6 sensed secondly after entering underneath the aircraft 1 from the front of the aircraft 1.

Conversely, in a state in which the second sensor unit 240 senses the shape of the rear of the aircraft 1 to determine that the second moving robot 200 is adjacent to the rear of the aircraft 1, the second moving robot 200 moves from the rear of the aircraft 1 to the lower portion of the aircraft 1 and may then approach between both wheels 6 sensed first.

The second sensor unit 240 may transmit the sensed position of the wheel 6 to the second controller 250, and the second moving robot 200 may move toward and approach the corresponding wheel 6 of the second landing gear 5 disposed in the lower portion of the aircraft 1 under the control of the second controller 250, and then, each of front and rear wing members 231 is unfolded for each pair of swing units 230 to narrow a gap between the two wing members 231.

Accordingly, the wheel 6 may be restrained in the front and rear sides by the wing members 231 of each of the swing units 230 and may be simultaneously supported while being lifted from the ground.

The second moving robot 200 may perform autonomous driving, and a driving direction, a driving speed, a turning direction, a turning speed, a stopping position, an obstacle avoidance, an emergency stop, and the like may be controlled by the second controller 250. In order to control such autonomous driving, the second moving robot 200 may be equipped with a battery (not illustrated).

Similarly, since various technologies have been proposed and are known for controlling a moving robot or vehicle by a controller, such as the second controller 250, for autonomous driving, a detailed description thereof will be omitted in this specification.

The second controller 250 may control a motor, such as an in-wheel motor, provided for each second wheel 220 of the second moving robot 200 and a second drive motor of the driver 232 driving the wing member 231. Accordingly, the second controller 250 may control the in-wheel motor to control the driving and steering of the second moving robot 200 and may control the second drive motor of the driver 232 so that the wing members 231 may restrain the wheel 6 of the second landing gear 5 and may simultaneously lift the wheel 6.

The second controller 250 may be implemented with various processing devices such as a microprocessor embedded with a semiconductor chip capable of performing various operations or commands, and various implementation methods are already widely known, and thus, further explanation thereof is omitted.

The second controller 250 may include a second memory 260 or may be electrically connected thereto. The second memory 260 may store various programs and data for driving the second moving robot 200. The second memory 260 may share and store a previously generated map and coordinate system of a take-off and landing site with the control device 300.

Additionally, the second controller 250 may be electrically connected to a second communication module 270 and may communicate with the control device 300 and the first moving robot 100 through the second communication module 270.

The second communication module 270 may be connected to at least one of, for example, wireless communication or wired or wireless communication. For example, the second communication module 270 may wirelessly receive a control signal from the control device 300 and may transmit state information of the second moving robot 200 to the control device 300.

Furthermore, the second communication module 270 may communicate with the first moving robot 100 and may receive information on a position or a state of the first moving robot 100, and conversely, the second communication module 270 may transmit the information on the position or the state of the second moving robot 200 to the first moving robot 100.

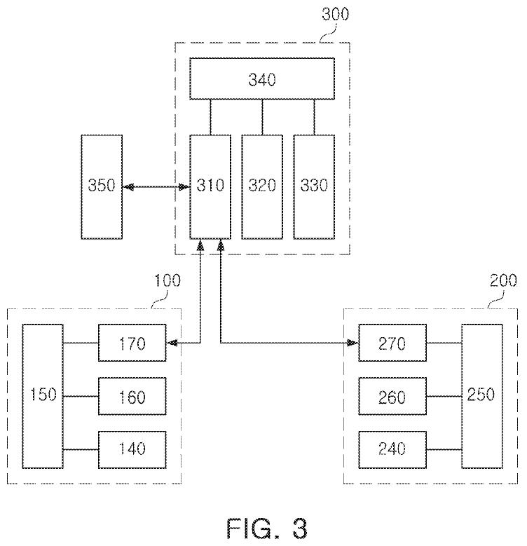

FIG. 3 is a block diagram schematically illustrating a control relationship of an apparatus for moving an aircraft according to embodiments of the present disclosure.

The control device 300 may include a communication unit 310, a path generation unit 320, a storage unit 330, and a control unit 340.

The communication unit 310 may be electrically connected to the first moving robot 100 and the second moving robot 200, for example, through a wireless or wired/wireless communication network. The communication unit 310 may collect state information through communication from the first moving robot 100 and the second moving robot 200 and may transmit a control signal to the first moving robot 100 and the second moving robot 200. Here, the state information may include data obtained from each of the sensor units 140 and 240 of each moving robot and data obtained from an encoder mounted on each motor.

The path generation unit 320 may generate a movement path from a current position (a starting point) to the destination for driving control of each of the moving robots 100 and 200. Specifically, the path generation unit 320 may generate paths for platooning synchronized with each other, depending on positions of each moving robot.

For example, a movement path may be set based on a coordinate system of a map and may include a plurality of nodes on the movement path. Accordingly, each of the moving robots 100 and 200 may move to a destination while sequentially passing through node 1, node 2, . . . , and node Z, in set movement paths.

The storage unit 330 is a type of database, and the storage unit 330 may store various programs and data required for controlling an operation of each of the moving robots 100 and 200 and controlling the platooning of the moving robots 100 and 200 and information generated according to the operation of the apparatus for moving an aircraft.

The control unit 340 may control an overall operation of the first moving robot 100 and the second moving robot 200. The control unit 340 may grasp state information of each of the moving robots 100 and 200 and may control each of the moving robots 100 and 200 to move along a movement path thereof, especially along the path of platooning synchronized with each other.

Optionally, the control device 300 may further include a terminal 350 that allows a worker to input information or commands related to the movement of the aircraft 1 and displays the information received from each of the moving robots 100 and 200. The terminal 350 may provide a setting screen for a destination and a movement path to receive setting information and may display monitoring information for each of the moving robots 100 and 200.

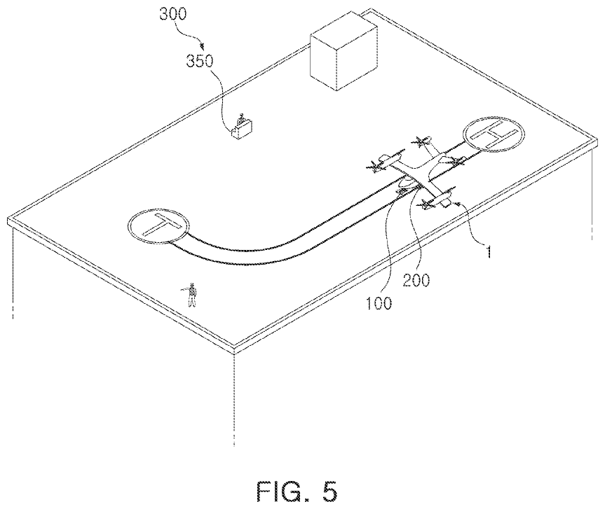

FIG. 4 is a side view illustrating an operating state of an apparatus for moving an aircraft according to embodiments of the present disclosure, and FIG. 5 is a view illustrating an application example of an apparatus for moving an aircraft according to embodiments of the present disclosure.

The first moving robot 100 and the second moving robot 200 of embodiments of the present disclosure may be applied to, for example, the aircraft 1 such as an urban air mobility. The aircraft may be used to transport individuals or a plurality of passengers within a city center or between city centers. Additionally, the aircraft may also be used for cargo delivery, such as a courier service.

Here, the aircraft 1 may refer to a vehicle configured to fly and move through the air. In other words, the aircraft 1 may refer to not only a fixed-wing aircraft but also a drone, a tilt rotor aircraft, a vertical take-off and landing aircraft, a rotary-wing aircraft, and the like, and it may also include a vehicle that may land and taxi on the ground or a structure using landing gears 3 and 5 after the flight.

Furthermore, the aircraft 1 may include a manned aircraft and an unmanned aircraft. The manned aircraft may include an aircraft that can operate by autonomous flight in addition to an aircraft controlled by a pilot.

For convenience of explanation, the first moving robot 100 and the second moving robot 200 according to embodiments of the present disclosure will be explained and illustrated with an example applied to a tilt-rotor aircraft or a vertical take-off and landing aircraft capable of take-off and landing at a narrow take-off and landing site. However, application examples of moving robots according to embodiments of the present disclosure are not necessarily limited thereto.

Additionally, in the aircraft 1, one first landing gear 3 may be disposed in a center between a left side and a right side of the fuselage 2 in the front or rear of the aircraft 1 and two second landing gears 5 may be arranged symmetrically to each other on left and right sides of the fuselage 2, relatively behind or in front of the first landing gear 3 disposed in the center. That is, the aircraft 1 may be equipped with three landing gears. However, the arrangement and number of landing gears are not limited to the examples described above and illustrated.

Since the aircraft 1 to which the apparatus for moving the aircraft according to embodiments of the present disclosure is applied is a tricycle type with three landing gears 3 and 5, when performing platooning by lifting the fuselage 2, the first moving robot 100 and the second moving robot 200 may be controlled and moved to ensure appropriate balance in consideration of the center of gravity of the aircraft 1.

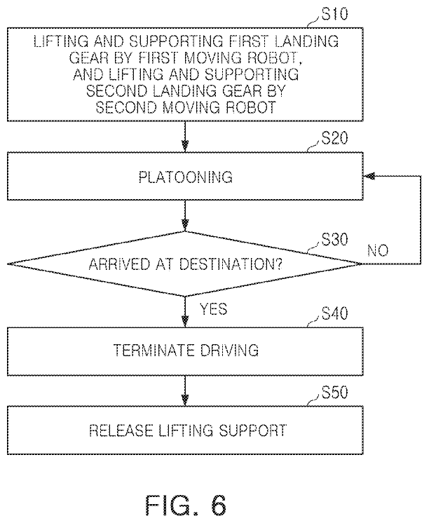

FIG. 6 is a flowchart illustrating a method for moving an aircraft according to embodiments of the present disclosure.

The method for moving an aircraft according to embodiments of the present disclosure may include an operation of lifting and supporting the wheel 4 on one first landing gear 3 of the aircraft 1 by the first moving robot 100 and lifting and supporting the wheels 6 on a plurality of second landing gears 5 of the aircraft 1 by the second moving robot 200 (S10) and an operation of performing platooning by the first moving robot 100 and the second moving robot 200 in a state in which the first moving robot 100 lifts and supports the wheel 4 of the first landing gear 3 and the second moving robot 200 lifts and supports the wheels 6 of the second landing gears 5 (S20).

First, in a state in which the aircraft 1 lands at a take-off and landing site, the first moving robot 100 may sense a location of the aircraft 1 and may move toward the stationary aircraft. The first moving robot 100 may enter space below the aircraft 1 and may move to a center of a wheel width of the wheel 4 constituting the first landing gear 3.

Then, the first moving robot 100 may move to push the slide 132 between the wheel 4 and the ground, and when the wheel 4 goes over the slide 132 and enters a space between the arm members 131, the unfolded guides 133 move toward each other and are in contact with each other.

Then, the support portion 134 may move toward the guides 133, and the wheel 4 may be restrained in front and rear sides by the support portion 134 together with the guides 133 and may be simultaneously supported while being lifted from the ground.

The second moving robot 200 may sense the position of the aircraft 1 and move toward the stationary aircraft. The second moving robot 200 may enter space below the aircraft 1 and move between both wheels 6 constituting the two second landing gears 5.

Then, each of the front and rear wing members 231 is unfolded for each pair of swing units 230 to narrow a gap between the two wing members 231.

Accordingly, the wheels 6 may be restrained in the front and rear sides by the wing members 231 of each of the swing units 230 and may be simultaneously supported while being lifted from the ground (S10).

Next, according to setting information on a destination and a movement path input by a worker into the terminal 350, the path generation unit 320 of the control device 300 generates paths for platooning synchronized with each other according to the positions of each of the moving robots 100 and 200.

The control unit 340 of the control device 300 may control each of the moving robots 100 and 200 to move along a movement path, particularly along a platooning path synchronized with each other.

Specifically, the control unit 340 may transmit a control signal to each of the moving robots 100 and 200, and the control signals may include at least one of a movement direction at a current position, a movement speed, destination coordinates, and a movement path and may be synchronized with each other.

The control unit 340 may transmit synchronized control signals for platooning to each of the first controller 150 of the first moving robot 100 and the second controller 250 of the second moving robot 200, through communication between the communication unit 310 and the first communication module 170 or the second communication module 270. Accordingly, the first controller 150 may control an in-wheel motor to control the driving and steering of the first moving robot 100, and the second controller 250 may control the in-wheel motor to control the driving and steering of the second moving robot 200.

In this case, the first moving robot 100 and the second moving robot 200 may communicate with each other and share information on a position or a state of each of the moving robots.

Additionally, each of moving robots 100 and 200 may move along a set movement path and may simultaneously transmit status information, including data obtained from the sensor units 140 and 240 of each of the moving robots 100 and 200 and data acquired from an encoder mounted on a motor, etc., to the control device 300 in real time.

Accordingly, the first moving robot 100 and the second moving robot 200 may perform platooning under the control of the control device 300 (S20).

The control unit 340 of the control device 300 may determine whether the first moving robot 100 and the second moving robot 200 have arrived at a destination, based on the state information received from the first moving robot 100 and the second moving robot 200 through communication (S30).

When the first moving robot 100 and the second moving robot 200, that is, the aircraft 1, arrive at the destination, the control unit 340 may terminate the driving of each of the moving robots by transmitting the synchronized control signals for driving stop to each of the first controller 150 and the second controller 250 through communication (S40).

Then, a lifting support of the aircraft 1 may be released from each of the moving robots 100 and 200 (S50). The release may be implemented by performing the operations of the plurality of first wheels 120, the pair of guides 133, and the support portion 134 of the first moving robot 100, and the pair of swing units 230 of the second moving robot 200 described above, in reverse order.

When the release is completed, the first moving robot 100 and the second moving robot 200 may report the completion of the release to the control device 300 through communication and may autonomously drive and return to an original location or an arbitrary waiting position.

As described above, according to an embodiment of the present disclosure, since the aircraft is at least partially lifted and moved using the moving robot and without towing the aircraft, it may be possible to quickly and safely move the aircraft even within a narrow space with a free transfer trajectory.

Furthermore, according to an embodiment of the present disclosure, automatic movement may be performed through the moving robot, significantly reducing worker man-hours, and furthermore, since heavy tow bars and the like are not used, musculoskeletal diseases and safety accidents of workers may be prevented in advance.

Furthermore, according to an embodiment of the present disclosure, the moving robot driven by a motor may be utilized, and even if the moving robot is driven within the city center, environmental problems such as air pollution and noise pollution may be resolved.

The aforementioned description merely illustrates the technical concept of embodiments of the present disclosure, and a person skilled in the art to which the present disclosure pertains may make various modifications and modifications without departing from the essential characteristics of the present disclosure.

Therefore, the example embodiments disclosed in the specification and drawings are not intended to limit but to explain the technical concept of the present disclosure, and the scope of the technical idea of the present disclosure is not limited by these example embodiments. The scope of protection of the present disclosure should be interpreted by the following claims, and all technical ideas within the scope equivalent thereto should be interpreted as being included in the scope of the present disclosure.

What is claimed is:

1. An apparatus for moving an aircraft, the apparatus comprising:
a first moving robot configured to lift and support a first landing gear of the aircraft;
a second moving robot configured to lift and support a plurality of second landing gears of the aircraft; and
a control device electrically connected to the first moving robot and the second moving robot, respectively, wherein the control device is configured to transmit a synchronized control signal to enable the first moving robot and the second moving robot to perform platooning.

2. The apparatus according to claim 1, wherein the first moving robot comprises:
a first frame;
at least two pairs of first wheels respectively disposed on both sides of the first frame in left and right directions; and
an arm portion disposed on a first side of the first frame in a front-rear direction, wherein the arm portion is configured to support a wheel of the first landing gear in a state in which the wheel is restrained and lifted at front and rear sides.

3. The apparatus according to claim 2, wherein the first wheels of the first moving robot are configured to be driven independently to drive and steer the first moving robot.

4. The apparatus according to claim 2, wherein the arm portion comprises:
a pair of arm members extending in the front-rear direction from the first side of the first frame;
a slide connecting first ends of the pair of arm members and having an inclined surface on a first side thereof;
a pair of guides disposed on a second side of the slide, opposite the first side, wherein the guides are configured to be capable of reciprocating in left and right directions of the first frame; and
a support portion disposed between the pair of arm members.

5. The apparatus according to claim 4, wherein:
each guide of the pair of guides has an inclined surface formed downwardly toward an interior of the first frame on a first side of the guide; and
the support portion has an inclined surface formed downwardly toward an exterior of the first frame on a first side of the support portion and corresponding to the inclined surfaces of the guides.

6. The apparatus according to claim 5, further comprising:
a buffer member comprising an elastic material mounted on the inclined surfaces of the guides and the inclined surface of the support portion; or
a plurality of rolling members arranged in the left and right directions of the first frame mounted on the inclined surfaces of the guides and the inclined surface of the support portion.

7. The apparatus according to claim 4, wherein the support portion is configured to enable linear reciprocating movement on the arm members.

8. The apparatus according to claim 4, wherein the first moving robot comprises:
a first sensor unit configured to sense a position of the wheel of the first landing gear and a surrounding environment; and
a first controller electrically connected to the first sensor unit and configured to control driving of the first wheels of the first moving robot and driving of the pair of guides.

9. The apparatus according to claim 8, wherein:
the first controller comprises a first memory or is electrically connected to the first memory; and
the first memory is configured to share a map and a coordinate system stored in the first memory with the control device.

10. The apparatus according to claim 8, wherein the first controller is electrically connected to a first communication module and is configured to communicate with the control device and the second moving robot through the first communication module.

11. The apparatus according to claim 1, wherein the second moving robot comprises:
a second frame;
at least two pairs of second wheels respectively disposed on both sides of the second frame in left and right directions, wherein the second wheels of the second moving robot are configured to be driven independently to drive and steer the second moving robot; and
a pair of swing units respectively disposed on both sides of the second frame in the left and right directions and configured to support wheels of the second landing gears while lifting the wheels of the second landing gears.

12. The apparatus for moving an aircraft according to claim 11, wherein the swing unit comprises:
a pair of wing members disposed to be spaced apart from each other in a front-rear direction on one side of the second frame, wherein, in a state in which each wing member of the pair of wing members is unfolded to narrow a gap between the pair of wing members, the wheels of the second landing gears are supported while being lifted on the pair of wing members; and
a driver connected to one end of each wing member of the pair of wing members and configured to rotate the pair of wing members.

13. The apparatus according to claim 12, wherein:
each wing member of the pair of wing members has an inclined surface extending downwardly toward the other wing member of the pair of wing members such that the inclined surfaces of the pair of wing members face each other in an unfolded state; and
the apparatus further comprises:
a buffer member comprising an elastic material disposed on the inclined surfaces of the pair of wing members; or
a plurality of rolling members arranged along each wing member in a longitudinal direction, the plurality of rolling members being mounted on the inclined surfaces.

14. The apparatus according to claim 11, wherein the second moving robot comprises:
a second sensor unit configured to sense a position of the wheels of the second landing gears and a surrounding environment; and
a second controller electrically connected to the second sensor unit and configured to control driving of the second wheels of the second moving robot and driving of the swing units.

15. The apparatus according to claim 14, wherein:
the second controller comprises a second memory or is electrically connected to the second memory; and
the second memory is configured to share a map and a coordinate system stored in the second memory with the control device.

16. The apparatus for moving an aircraft according to claim 14, wherein the second controller is electrically connected to a second communication module and is configured to communicate with the control device and the first moving robot through the second communication module.

17. An apparatus for moving an aircraft, the apparatus comprising:
a first moving robot configured to lift and support a first landing gear of the aircraft;
a second moving robot configured to lift and support a plurality of second landing gears of the aircraft; and
a control device electrically connected to the first moving robot and the second moving robot, respectively, wherein the control device is configured to transmit a synchronized control signal to enable the first moving robot and the second moving robot to perform platooning, and wherein the control device comprises one or more processors and a storage device storing data and a program to be executed by the one or more processors, the program including instructions for:
communicating with the first moving robot and the second moving robot;
generating a synchronized platooning path according to positions of the first moving robot and the second moving robot in a coordinate system of a map; and
grasping state information of the first moving robot and the second moving robot and controlling the first moving robot and the second moving robot to move along the platooning path.

18. The apparatus according to claim 17, wherein the control device further comprises a terminal configured to receive setting information for a destination and a movement path and to display monitoring information of the first moving robot and the second moving robot.

19. A method for moving an aircraft, the method comprising:
lifting and supporting, by a first moving robot, a first landing gear of the aircraft;
lifting and supporting, by a second moving robot, a plurality of second landing gears of the aircraft; and
performing platooning by the first moving robot and the second moving robot.

20. The method according to claim 19, wherein lifting and supporting the first landing gear comprises the first moving robot entering underneath the aircraft and moving to a center of a wheel width of a wheel of the first landing gear, and wherein lifting and supporting the plurality of second landing gears comprises the second moving robot entering underneath the aircraft and moving between wheels of the plurality of second landing gears.
